(19) United States
(12) Patent Application Publication
(10) Pub. No.: US 2007/0102358 A1
(43) Pub. Date: May 10, 2007

(54) Solid phase extraction column

(75) Inventor: Thomas J. Good, Sierra Madre, CA (US)

Correspondence Address: SHELDON MAK ROSE & ANDERSON PC, 225 SOUTH LAKE AVENUE, 9TH FLOOR, PASADENA, CA, 91101, US

(73) Assignee: CERA Inc.

(21) Appl. No.: 11/272,290

(22) Filed: Nov. 9, 2005

(51) Int. Cl. C02F 1/42

(52) U.S. Cl. 210/638; 210/266; 210/498; 422/101

(57) ABSTRACT

An apparatus comprising a container or housing, such as a microcolumn, which contains an analyte separation (i.e., extraction) system is provided. The analyte separation system houses a separation media having a particle size diameter of greater than about 30 microns in diameter that is substantially free of interfering contaminants.

### RELATED APPLICATION

This application is related to U.S. patent application Ser. No. 08/275,781, filed on Dec. 30, 2003, which is an application under section 371(c) of PCT/US96/11300, filed on Jul. 3, 1996, which is a continuation-in-part of U.S. Pat. No. 5,595,653, filed on Jul. 15, 1995, all of which are herein incorporated by reference.

### BACKGROUND

The present invention relates to microcolumns for separating an analyte (or target substance) from a liquid sample, and particularly, the separation of an analyte from biological fluids, such as blood and urine.

Solid phase extraction (SPE) is a chromatographic technique used to concentrate an analytical sample, or to isolate an analyte (or target substance) of interest by removing impurities and other interfering substances that may be present in the sample. This is done by selectively separating the analyte from the liquid sample on a separation media, either by keeping the analyte of interest and washing off the impurities (followed by elution of the analyte), or by retaining the impurities and eluting the analyte of interest. After the analyte is removed from the separation media, tests are conducted to qualify and/or quantify the analyte, such as by gas or liquid chromatography.

Solid phase extraction columns having microparticulate separation media, also referred to as a sorbent, in the 5-20 μm range are known. Further information on these types of columns can be found in U.S. Pat. No. 5,595,653; and PCT/US96/11300, incorporated herein by reference.

Known solid phase extraction columns are prepared either by “slurry packing”, or dry packing” the separation media into a column. Columns having microparticulate sorbents are generally prepared using the slurry packing technique due to the difficulty in dry packing microparticulate separation media. According to this method, the separation media, such as silica or a polymeric powder, is suspended in a liquid and forced into a separation column. Disadvantageously, however, these columns are more expensive than conventional columns, i.e., those having particulate sorbents in the 40 μm range, and existing analytical systems and methodologies are formatted for conventional extraction columns. Further, the slurry packing technique generally requires the use of expensive instrumentation to load the separation column with the slurry.

Conventional solid phase extraction columns having larger particulate sorbents, in the 40 μm range, are also known. Columns having particulate sorbents in the larger, 40 μm range, are generally prepared by the dry packing technique due to the expense and difficulty involved in using the slurry packing technique. According to this method, the separation media is forced in its dry form into a separation column with the resulting sorbent bed being retained between a porous frit material. Disadvantageously, however, these columns may suffer from being under-packed, i.e., the loose particulate bed settles with time or under pressure leaving voids behind, or over-packed, i.e., the particulate bed is compressed and flow is restricted through the column. In addition, these columns may contain extractable substances in the porous frit material or sorbent which appears in the final eluate, causing interference with analyte qualification/quantification. Finally, these columns can have an unsuitable “dead” volume in the porous frit.

Therefore, there is a need for a small-scale solid phase extraction column that is tightly packed, i.e., the sorbent bed is substantially uniform throughout the entire column, that is compatible with existing analytical systems and methodologies, and that is substantially free from interfering contaminants. In addition, there is a need for a solid phase extraction column having a reduced “dead” volume.

### SUMMARY

The present invention is directed to an extraction device that meets these needs. The apparatus is useful for separating an analyte from a liquid sample. In one embodiment, the invention comprises a container having an entrance, an exit, and a passage therebetween for passing a liquid sample containing an analyte through the passageway. Within the passage is a layer of separation media having a top surface, a bottom surface, and a peripheral edge. The separation media has a particle size of greater than about 30 microns in diameter, and is substantially free of substances having a deleterious effect on the separation of the analyte from the liquid, and the quantification or qualification of the separated analyte, i.e., interfering contaminants. Preferably, the layer of separation media is between about 5 mm and about 15 mm in length. The layer of separation media layer is oriented in the passage so that liquid flows through the layer of separation media layer from its top surface to the bottom surface.

The layer of separation media is formed between an upper compression layer at the top surface of the separation media layer and a lower compression layer at the bottom surface of the separation media layer, which compress the layer of separation media therebetween. The compression layers are sufficiently porous that the liquid sample flows therethrough, and are formed of a flexible, hydrophilic, microfiber material and has a pore size that is less than the particle size of the separation media.

The apparatus also contains an upper mesh flow distributor above the upper compression layer and a lower mesh flow distributor below the lower compression layer. The flow distributors sandwich the extraction media and the compression layers in the microcolumn and help distribute the flow of the liquid sample uniformly to the top surface of the separation media, which helps avoid channeling. The apparatus may additionally have a retainer that is positioned on top of the upper mesh flow distributor, and/or the apparatus may have an adapter, such as a luer tip on one or both ends of the container.

The separation media is a sorbent which can be chemically modified, wherein the sorbent surface is substantially free of residual substances resulting from the surface modification process. More preferably, the chemically modified sorbent is a non-polar sorbent, a polar sorbent, or an ion-exchange sorbent. Most preferably, the non-polar sorbent has a non-polar functionality selected from the group consisting of octadecyl (C18), octyl (C8), butyl (C4), ethyl (C2), cyclohexyl, phenyl, and diphenyl; and the polar sorbent has a polar functionality selected from the group consisting of cyano, diol, and hydroxylated groups; and the ion-exchange sorbent has an ionic functionality selected from the group consisting of an amino, amine, quaternary amine, imino, sulfonic acid, carboxylic acid, and acetic acid.

According to the present invention, the separation media is substantially free of interfering contaminants, meaning those substances that have a deleterious effect on the separation of the analyte from the liquid, and/or the quantification and/or qualification of the separated analyte. This can be accomplished by slurry packing or washing the separation media with an appropriate solvent, i.e., packing liquid, during or prior to column packing. Preferably, when the separation media is a chemically modified sorbent having a non-polar functionality, the packing liquid is a polar solvent, and when the separation media is a chemically modified sorbent having a polar functionality, including negatively or positively charged functionalities used in ion-exchange sorbents, the packing liquid is a non-polar solvent.

Slurry packing the separation media into the container also contributes to forming a tightly packed column. Preferably, in an apparatus having a separation layer of about 10 mm, the fill weight of the separation media will be about 100 mg, and up to about 500 mg.

In another embodiment, the invention is a method of preparing an apparatus for separating an analyte from a liquid sample. According to this embodiment, the method comprises providing a container having an entrance, an exit, and a passage therebetween for passage of a liquid sample. Then, according to the method, a lower mesh flow distributor is placed above the exit of the container and a lower compression layer is placed on top of the lower mesh flow distributor. Next, a separation media, having a particle size of greater than about 30 microns in diameter, is prepared with a packing liquid, where the packing liquid substantially removes all substances having a deleterious effect on the separation of the analyte from the liquid, and the quantification or qualification of the separated analyte. A stable slurry of the separation media and packing liquid preparation is then formed, and the container is filled with the slurry to form a layer of separation media above the lower compression layer. Then, an upper compression layer is placed layer on top of the separation media layer and an upper mesh flow distributor is placed on top of the upper compression layer. Optionally, a retainer can be placed on top of the upper mesh flow distributor.

Due to the separation media being substantially free of interfering contaminants, the apparatus has a “clean” separation layer and additional solvent washing by the end-user in an extraction methodology, prior to isolation of the analyte or target substance of interest is not necessary. Further, the separation apparatus employs conventionally sized separation media, ie., a sorbent having a particle size diameter greater than about 30 microns, so the apparatus is compatible with existing analytical systems and methodologies.

### FIGURES

These and other features, aspects and advantages of the present invention will become better understood from the following description, appended claims, and accompanying figures where:

FIG. 1 is a perspective view of one version of a microcolumn according to the present invention;

FIG. 2 is a side elevation view, exploded, partly in section, of region 2 of the microcolumn of FIG. 1, showing one embodiment of the separation system according to the present invention;

FIG. 3 is a side elevation view, partly in section, of the microcolumn of FIG. 1 and FIG. 2, showing region 2 of FIG. 1;

FIG. 4A is a partial cut-away perspective view of another embodiment of the separation system of the microcolumn of FIG. 1; and

FIG. 4B is a partial cut-away expanded perspective view of region 4B of the microcolumn of FIG. 4A.

### DESCRIPTION

According to the present invention, an apparatus for separating an analyte (or target substance) from a liquid sample is provided. The apparatus comprises a container or housing, such as a microcolumn, which contains an analyte separation (i.e., extraction) system. The analyte separation system houses a separation media having a diameter of greater than about 30 microns with an average particle size diameter of about 40 microns and that is substantially free of substances having a deleterious effect on the separation of the analyte from the liquid, and the quantification or qualification of the separated analyte (i.e., interfering contaminants).

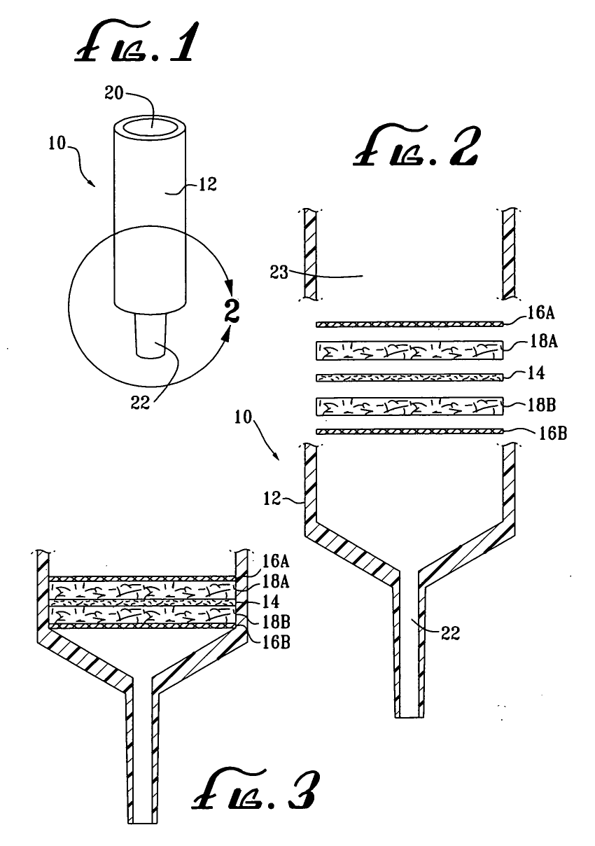

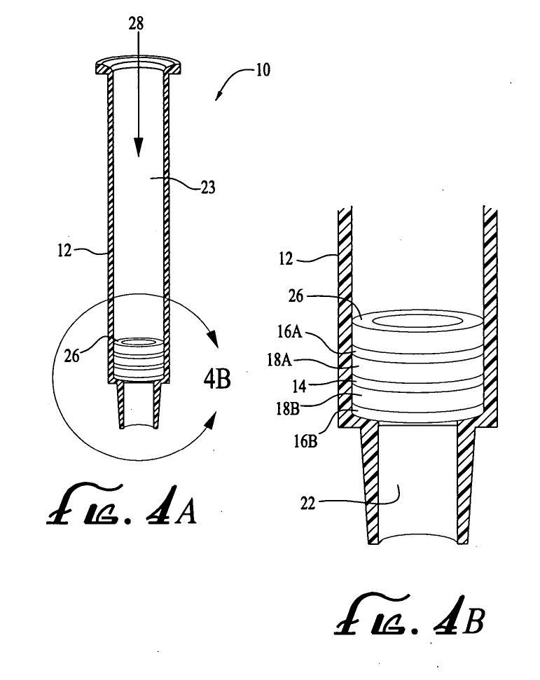

Referring now to FIGS. 1, 2, and 3, the apparatus 10 for extracting an analyte from a liquid sample is shown. FIG. 1 is a perspective view of one version of a microcolumn apparatus 10 according to the present invention. As shown in FIG. 1, the apparatus 10 comprises a microcolumn 12, which serves as a container for an analyte separation system, which is housed in region 2 of the microcolumn 12. As shown in FIGS. 2 and 3, the analyte separation system is comprised of a layered construction. The analyte separation system includes (i) a separation layer 14 comprising a separation medium; (ii) an upper flow distributor 16A; (iii) a lower flow distributor 16B; (iv) an upper compression layer 18A between the upper flow distributor 16A and the separation layer 14; and (v) a lower compression layer 18B between the lower flow distributor 16B and the separation layer 14.

The microcolumn 12 generally has a tubular configuration, and has an entrance 20, an opposed exit 22, and a passage 23 therebetween. The passage 23, also referred to as a central bore, contains the analyte separation system. The exit 22 may additionally have an adapter 24 which is configured to allow the apparatus 10 to be used with conventional automated extraction devices. In one embodiment, the adapter 24 is integrated into the microcolumn 12. In another embodiment, the adapter 24 is a separate (i.e., removable) part. Preferably, the adapter 24 is in the form of a luer tip, such as a luer slip or luer lock, which allows the microcolumn 12 to be used with a device, such as a vacuum extraction apparatus, which is designed to receive an extraction column having a luer tip.

Referring now to FIGS. 4A and 4B, FIG. 4A is a partial cut-away perspective view of another embodiment of the separation system of the microcolumn of FIG. 1, and FIG. 4B is a partial cut-away expanded perspective view of region 4B of the microcolumn of FIG. 4A. As shown in FIGS. 4A and 4B, the microcolumn 12 may optionally contain a retainer 26, which is housed in the passage 23 of the microcolumn 12 and is positioned above the upper flow distributor 16A. The retainer 26 is further described in PCT/US96/11300, incorporated herein by reference.

Referring again to FIG. 4A, the portion of the microcolumn 12 above the analyte separation system serves as a reservoir for a liquid sample, from which an analyte is to be extracted, and also a reservoir for an eluent liquid. The liquid sample and eluent liquid flow in the direction of arrow 28 shown in FIG. 4A through the passage 23.

All of the components of the apparatus 10 are made of materials that are substantially inert to the liquid sample and eluent liquid. For example, when the liquid sample is a biological fluid such as blood or urine, the biological sample is passed through the apparatus 10 and substantially nothing passes from the apparatus 10 into the biological sample. Preferably, the microcolumn 12 is made of polypropylene, or alternatively, a fluorinated polymer.

A typical microcolumn 12 of the present invention has an internal diameter of about ¼ to 1 inch, and a length, excluding the luer tip, of about 2 to about 6 inches.

The microcolumn 12 need not have the shape shown in FIGS. 1-4. For example, the microcolumn need not be cylindrical in horizontal cross-section. In addition, in one embodiment of the invention, the entrance 20 can be designed to receive a luer-lock extension so that a reservoir containing a liquid sample can be piggybacked on top of the microcolumn 12.

The separation layer 14 is comprised of a separation media which may be of various materials known to those of skill in the art, such as silica, chemically modified silicas, constituted pure glass, and polymeric resins such as divinyl benzene and chemically modified divinyl benzenes. The separation media particles have a diameter greater than about 30 microns. Generally, the average particle size of the separation media is about 40 microns in diameter, and preferably, the separation media particles are substantially of a particle size of between about 32 microns to about 63 microns in diameter.

The average pore size of the separation layer 14 is about 60 angstroms. However, in other embodiments, a “wide pore” separation layer can be formed with a pore size from between about 300 angstroms to about 100 angstroms.

Typically, the thickness of the separation layer 14 is greater than about 4 mm in length and less than about 20 mm in length, and preferably about 10 mm in length.

Preferably, the separation media (i.e., sorbent) is tightly packed within the separation layer 14 of the microcolumn 12, i.e., the separation media is substantially uniform throughout the entire separation layer 14. It has been found that a tightly packed bed is important for good, reproducible chromatographic performance of the separation apparatus. Preferably, for a microcolumn apparatus having a separation layer 14 of about 10 mm in length, the fill weight of the separation media is from about 200 mg, and up to about 500 mg.

A tightly packed column may be accomplished by placing the separation media in the microcolumn 12 using a slurry packing technique. According to this method, a slurry, i.e., a fluid comprising suspended particles of separation media and a packing liquid is prepared. The slurry is prepared such that the slurry is reasonably stable, that is, the separation media should not significantly settle over a period of about 30 to about 45 seconds. Generally, for an accurate and reproducible fill weight, the slurry should have the aforementioned stability characteristic. Next, under constant agitation, such by using mechanical stirring, aliquots of the slurry are pumped at about 15 psi into the entrance 20 of the microcolumn 12. The packing liquid passes through the exit 22 of the microcolumn 12 and out of the tube, while the separation media remains behind in the microcolumn 12. Thus, the lower compression layer 18B and the lower flow distributor 16B serve to “filter” the separation media from the packing liquid. The packing rate, and the flow rate of the packing liquid through the microcolumn 12 may decrease as packing progresses and the amount of packing built-up behind the lower compression layer 18B and the lower flow distributor 16B increases. To compensate for the increased back-pressure, and maintain a constant flow rate, the pressure of the slurry entering the tube may be increased.

The selection of the packing liquid, in addition to resulting in a stable slurry, should have the ability to remove any residual interfering substances from the surface of the separation media. That is, the separation media is substantially free of substances having a deleterious effect on the separation of the analyte from the liquid, and/or substances that substantially interfere with the quantification or qualification of the separated analyte. Further, the packing liquid should not result in the addition of contaminating materials which can adsorb onto the surface of the separation media. Such contaminating materials include those in the packing liquid itself, or the interaction of the packing liquid with the surface of the separation media, such as with hydrogen bonding. Contamination of the surface of the separation media can mitigate the intended chromatographic interaction with the sample to be separated, thereby resulting in poor recovery of the intended target sample. The packing liquid is selected depending on the type of separation media that is used for a particular microcolumn separation apparatus, as will be understood by those of skill in the art with reference to this disclosure, including the examples herein described.

Preferably, the separation media is a chemically modified sorbent and the sorbent surface is substantially free of residual interfering substances, such as those resulting from the surface modification process, i.e., substances having a deleterious effect on the separation of the analyte from the liquid, or substances that substantially interfere with the quantification or qualification of the separated analyte. The chemically modified sorbent may be a chemically modified non-polar sorbent, a chemically modified polar sorbent, or a chemically modified ion-exchange sorbent. Preferably, the sorbent surface is made substantially free of interfering residual substances by slurry packing the separation layer 14 with an appropriate packing liquid that serves to “wash” the sorbent.

In one embodiment of the present invention, the separation media is a chemically modified non-polar sorbent. According to a preferred embodiment, the chemically modified non-polar sorbent is composed of a silica backbone having a non-polar functionality. Examples of non-polar functionalities include groups such as an octadecyl (C18), octyl (C8), butyl (C4), ethyl (C2), cyclohexyl, phenyl, or diphenyl group. However, other non-polar functionalities are known to those of skill in the art and can be used according to the present invention. Non-polar sorbents may be prepared according to known methods, or may be obtained from commercially available sources such as, J.T. Baker, Phillipsburg, and NJ; Silicycle, Quebec, QC, Canada. According to this embodiment, the separation media having the non-polar functionality is substantially free of residual interfering substances, such as those resulting from the surface modification process. This may be accomplished by slurry packing, or washing the sorbent with an appropriate packing liquid. Appropriate packing liquids are polar solvent such as alcohols, including methanol, ethanol, and isopropanol. Preferably, the packing liquid for a column having a non-polar sorbent is isopropanol.

In another embodiment of the present invention, the separation media is a chemically modified polar sorbent. According to a preferred embodiment, the chemically modified non-polar sorbent is composed of a silica backbone having a polar functionality. Examples of polar functionalities include groups such as amino, cyano, diol, or hydroxylated groups. However, other polar functionalities are known to those of skill in the art and can be used according to the present invention. Polar sorbents may be prepared according to known methods, or may be obtained from commercially available sources such as, J.T. Baker, Phillipsburg, and NJ; Silicycle, Quebec, QC, Canada. According to this embodiment, the separation media having the polar functionality is substantially free of residual interfering substances, such as those resulting from the surface modification process. This may be accomplished by slurry packing or washing the sorbent with an appropriate packing liquid. Appropriate packing liquids are non-polar solvents such as methyl acetate, ethyl acetate, and hexane. Preferably, the packing liquid for a column having a polar sorbent is methyl acetate.

In another embodiment of the present invention, the separation media is a chemically modified ion-exchange sorbent composed of a silica backbone bonded to a negatively or positively charged functional group. According to a preferred embodiment, the chemically modified ion-exchange sorbent is composed of a silica backbone having a positively charged functionality anion exchange, and a silica backbone having a negatively charged functionality for cation exchange. Examples of functionalities for anion exchange include groups such as an amino, amine, quaternary amine, or imine groups. Examples of functionalities for anion exchange include groups such as sulfonic, carboxylic, or acetic acid groups. However, other positively or negatively charged functionalities are known to those of skill in the art and can be used according to the present invention. Ion-exchange sorbents may be prepared according to known methods, or may be obtained from commercially available sources such as, J.T. Baker, Phillipsburg, and NJ; Silicycle, Quebec, QC, Canada. According to this embodiment, the separation media and the analyte or sample to be separated (i.e., extracted) are charged and the analyte is retained on the separation media through ionic bonds. Thus, if the separation media or analyte are neutralized, elution will not occur. According to this embodiment, the separation media having the negatively or positively charged functionality is substantially free of residual interfering substances, such as those resulting from the surface modification process, and the packing liquid will not neutralize the separation media or analyte. This may be accomplished by slurry packing or washing the sorbent with an appropriate packing liquid. Appropriate packing liquids are non-polar solvents such as methyl acetate, ethyl acetate, and hexane. Preferably, the packing liquid for a column having a polar sorbent is methyl acetate.

Table 1 below shows examples of appropriate sorbents and packing liquids for various analytes which are classified according to type of compound (e.g., small organic molecules such as drugs of abuse and pharmaceuticals; large organic molecules such as large peptides and oligonucleotides; trace metals, and metal chelates in solution), as well as molecular weight (MW), polarity, ionizability and solubility. However, Table 1 below is provided for exemplary purposes only and other combinations of chemically modified sorbent functionalities and packing liquids for particular analytes are possible as will be understood by those of skill in the art by reference to this disclosure.

TABLE 1

| ANALYTE | SORBENT | PACKING LIQUID |
|---|---|---|
| Small Organic Molecules (MW | Silica | Non-polar Solvents (e.g., |
| <2000, Polar, Organic Solvent | Chemically Modified Polar | methyl acetate, ethyl acetate, |
| Soluble | Sorbents: Cyano (CN), Diol | and hexane). |
| | (COHCOH), Amino (NH₂/NH) | |
| Small Organic Molecules (MW | Silica | Non-polar Solvents (e.g., |
| <2000, Moderately Polar, | Chemically Modified Polar | methyl acetate, ethyl acetate, |
| Organic Solvent Soluble) | Sorbents: Hydroxyl (OH) | and hexane). |
| Small Organic Molecules (MW | Chemically Modified Non-polar | Polar Solvents (e.g., alcohols, |
| <2000, Non-Polar, Organic | Sorbents: Octadecyl (C18), Octyl | including methanol, ethanol, |
| Solvent Soluble) | (C8), Ethyl (C2), Cyclohexyl, | and isopropanol). |
| | Phenyl | |
| Small Organic Molecules (MW | Chemically Modified Anion | Non-polar Solvents (e.g., |
| <2000, Cationic, Water Soluble) | Exchange Sorbents: Cyano (CN), | methyl acetate, ethyl acetate, |
| | Carboxylic Acid (CO₂H), Sulfonic | and hexane). |
| | Acid (SO₃H) | |
| Small Organic Molecules (MW | Chemically Modified Cation | Non-polar Solvents (e.g., |
| <2000, Anionic, Water Soluble) | Exchange Sorbents: Amino | methyl acetate, ethyl acetate, |
| | (NH₂/NH), Quaternary Amine (N)⁺ | and hexane). |
| Small Organic Molecules (MW | Chemically Modified Polar | Non-polar Solvents (e.g., |
| <2000, Polar, Non-ionic, or Ion | Sorbents: Cyano (CN), Diol | methyl acetate, ethyl acetate, |
| Paired, Water Soluble) | (COHCOH), Amino (NH₂/NH) | and hexane). |
| Small Organic Molecules (MW | Silica | Non-polar Solvents (e.g., |
| <2000, Moderately-Polar, Non- | Chemically Modified Polar | methyl acetate, ethyl acetate, |
| ionic, or Ion Paired, Water | Sorbents: Hydroxyl (OH) | and hexane). |
| Soluble) | | |
| Small Organic Molecules (MW | Chemically Modified Non-Polar | Polar Solvents (e.g., alcohols, |
| <2000, Non-Polar, Non-ionic, | Sorbents: Octadecyl (C18), Octyl | including methanol, ethanol, |
| or Ion Paired, Water Soluble) | (C8), Ethyl (C2), Cyclohexyl, | and isopropanol). |
| | Phenyl | |
| Large Organic Molecules (MW | Chemically Modified Non-Polar | Polar Solvents (e.g., alcohols, |
| >2000, Organic Solvent | Sorbents: Wide-Pore Butyl (C4), | including methanol, ethanol, |
| Soluble) | Octadecyl (C18), Octyl (C8) | and isopropanol). |
| Large Organic Molecules (MW | Chemically Modified Anion | Non-polar Solvents (e.g., |
| >2000, Cationic, Water Soluble) | Exchange Sorbents: Wide-Pore | methyl acetate, ethyl acetate, |
| | Carboxylic Acid (COOH) | and hexane). |
| Large Organic Molecules (MW | Chemically Modified Cation | Non-polar Solvents (e.g., |
| <2000, Anionic, Water Soluble) | Exchange Sorbents: Wide Pore | methyl acetate, ethyl acetate, |
| | Amino | and hexane). |
| Trace Metals | Chemically Modified Ion-Exchange | Non-polar Solvents (e.g., |
| | Sorbents: Carboxylic Acid | methyl acetate, ethyl acetate, |
| | (CO₂H), Sulfonic Acid (SO₃H), | and hexane). |
| | Amino, Quaternary Amine (N)⁺ | |

The chief purpose of the compression layers 18A and 18B is to hold the separation media in place and compressed as a layer. Accordingly, the compression layers 18A and 18B have a pore size less than the particle size of the separation media. They are sufficiently porous that the liquid sample can flow therethrough, and are composed of a flexible, hydrophilic material. Preferably, the compression layers 18A and 18B are resilient or “spongy” to hold the separation media in place. A preferred pore size for the compression layer is less than 3 microns, and more preferably less than 1 micron. Generally, the compression layers 18A and 18B are the same thickness, typically, from about ¼ mm to about 1 mm, and preferably about ½ mm.

A suitable compression layer comprises a glass microfiber media made of analytically clean material. Suitable materials are available from Whatman Specialty Products, Inc. of Florham Park, N.J., include borosilicate glass fibers that are analytically clean and include no binder. This material, when purchased, has a smooth side and a rough side, where the smooth side is of lower porosity than the rough side. Preferably, it is the smooth side that is placed in contact with the separation media of the separation layer 14.

The flow distributors 16A and 16B help provide uniform flow of the sample through the column and physically retain the compression layers 18A and 18B and separation layer 14 in place in the column. As shown in FIG. 3, the lower flow distributor 16B seats against the sloped bottom portion of the microcolumn. The upper flow distributor 16A is sized so that it is held in the bore of the microcolumn 12 by a compression fit. Preferably, the flow distributors 16A and 16B are formed of a flexible mesh material, and the mesh has a 200 mesh or smaller size (i.e., has a mesh number of 200 or higher). The flexible mesh material is preferably a polymeric material such as polypropylene, or polytetrafluoroethylene. A suitable material is available from Tetko, Inc. of Briarcliff Manor, N.Y., under catalog number 5-420134.

According to another embodiment of the invention, a method of preparing an apparatus for separating an analyte from a liquid sample is provided. According to this method, first, a container having an entrance, an exit, and a passage therebetween for passage of a liquid sample is provided. Next, a lower mesh flow distributor is placed above the exit of the container and a lower compression layer is placed on top of the lower mesh flow distributor. Then, a separation media is prepared with a packing liquid, where the packing liquid substantially removes all substances having a deleterious effect on the separation of the analyte from the liquid sample and/or substances that substantially interfere with the quantification or qualification of the separated analyte. A stable slurry of separation media and packing liquid is then formed and the container is filled with the slurry to form a layer of separation media above the lower compression layer. An upper compression layer is then placed on top of the separation media layer and an upper mesh flow distributor is placed on top of the upper compression layer. Optionally, a retainer is placed on top of the upper mesh flow distributor.

The analyte separation system of the present invention provides an efficient flow distribution of exiting eluant, and has a reduced “dead” volume over known systems. As described, the apparatus 10 is easy and inexpensive to manufacture, is transportable, and efficiently and effectively removes analytes from liquid samples, requiring only small amounts of the liquid sample and small amounts of eluent fluid. The microcolumn 12 can easily be injected molded. Further, since the separation media employed in the apparatus is conventionally sized, the apparatus may be used with existing analytical systems and methodologies. Finally, as a particular advantage, the separation apparatus is substantially free of substances having a deleterious effect on the separation of the analyte so the column does not need to be preprocessed i.e., washed, prior to use, thereby reducing the labor costs and time required for analyzing a sample.

Although the present invention has been described in considerable detail with reference to certain preferred versions thereof, other versions are possible. For example, the apparatus 10 is not limited to use with biological fluids, but can be used, for example, for testing ground water, drinking water, and other liquids for contaminants, such as metals and organic compounds, or can be used for separating other target substances or analytes from various organic and inorganic fluids.

In addition, the separation media does not have to be homogenous, but rather a different separation media can be used in a single bed, or the apparatus can include multiple beds of separation media for separating different analytes from samples.

Therefore, the spirit and scope of the appended claims should not be limited to the description of the preferred versions contained herein.

What is claimed is:

1. Apparatus for separating an analyte from a liquid sample comprising:
a) a container having an entrance, an exit, and a passage therebetween for passage of a liquid sample containing an analyte therethrough;
b) a layer of separation media within the passage for separating the analyte from the liquid sample, wherein:
(i) the separation media layer has a top surface, a bottom surface, and a peripheral edge,
(ii) the separation media has a particle size of greater than about 30 microns in diameter;
(iii) the separation media is substantially free of substances having a deleterious effect on the separation of the analyte from the liquid, and the quantification or qualification of the separated analyte; and
(iv) the separation media layer is oriented in the passage so that liquid flows through the separation media layer from its top surface to the bottom surface;
c) an upper compression layer at the top surface of the separation media layer and a lower compression layer at the bottom surface of the separation media layer, the two compression layers pressing the separation media therebetween, the compression layers being sufficiently porous that the liquid sample flows therethrough, the compression layers being formed of a flexible, hydrophilic, microfiber material and having a pore size less than the particle size of the separation media;
d) an upper mesh flow distributor above the upper compression layer for distributing flow of the liquid sample uniformly to the separation media layer top surface; and
e) a lower mesh flow distributor below the lower compression layer.

2. The apparatus of claim 1 wherein the separation media is slurry packed into the container.

3. The apparatus of claim 1 wherein the separation media is a chemically modified sorbent and the sorbent surface is substantially free of residual substances resulting from the surface modification process.

4. The apparatus of claim 3 wherein the chemically modified sorbent is a non-polar sorbent.

5. The apparatus of claim 4 wherein the non-polar sorbent is a chemically modified sorbent having a non-polar functionality selected from the group consisting of octadecyl (C18), octyl (C8), butyl (C4), ethyl (C2), cyclohexyl, phenyl, and diphenyl.

6. The apparatus of claim 4 wherein the separation media is slurry packed into the container using a polar solvent.

7. The apparatus of claim 3 wherein the chemically modified sorbent is a polar sorbent.

8. The apparatus of claim 7 wherein the non-polar sorbent is a chemically modified sorbent having a polar functionality selected from the group consisting of cyano, diol, and hydroxylated groups.

9. The apparatus of claim 7 wherein the separation media is slurry packed into the container using a non-polar solvent.

10. The apparatus of claim 3 wherein the chemically modified sorbent is an ion-exchange sorbent.

11. The apparatus of claim 10 wherein the ion-exchange sorbent is a chemically modified sorbent having an ionic functionality selected from the group consisting of an amino, amine, quaternary amine, imino, sulfonic acid, carboxylic acid, and acetic acid.

12. The apparatus of claim 10 wherein the analyte is a water soluble, cationic, small organic molecule, and the ion-exchange sorbent is a chemically modified sorbent having an anion exchange functionality.

13. The apparatus of claim 10 wherein the separation media is slurry packed into the container using a non-polar solvent.

14. The apparatus of claim 1 wherein the layer of separation media is between about 5 mm and about 15 mm in length.

15. The apparatus of claim 1 wherein the separation layer has an average pore size of about 60 angstroms.

16. The apparatus of claim 1 wherein the separation layer has a pore size from between about 300 angstroms to about 1000 angstroms.

17. The apparatus of claim 1 wherein the layer of separation media is about 10 mm in length and has a fill weight of between about 100 mg and about 500 mg.

18. The apparatus of claim 1 further comprising a retainer.

19. The apparatus of claim 1 further comprising an adapter.

20. A method of preparing an apparatus for separating an analyte from a liquid sample comprising:
a) providing a container having an entrance, an exit, and a passage therebetween for passage of a liquid sample;
b) placing a lower mesh flow distributor above the exit of the container;
c) placing a lower compression layer on top of the lower mesh flow distributor;
d) preparing a separation media with a packing liquid, where the packing liquid substantially removes all substances having a deleterious effect on the separation of the analyte from the liquid, and the quantification or qualification of the separated analyte, and the separation media has a particle size of greater than about 30 microns in diameter;
e) forming a stable slurry of separation media and packing liquid;
f) filling the container with the slurry to form a layer of separation media above the lower compression layer;
g) placing an upper compression layer on top of the separation media layer; and
h) placing an upper mesh flow distributor on top of the upper compression layer.

21. The method according to claim 19 further comprising placing a retainer on top of the upper mesh flow distributor.

22. The method according to claim 19 wherein the separation media is a chemically modified anion exchange sorbent and the packing liquid is a non-polar solvent.

23. The method according to claim 22 wherein the chemically modified anion exchange sorbent has a functionality selected from the group consisting of cyano, carboxylic acid, and sulfonic acid.
